(19) United States
(12) Patent Application Publication
(10) Pub. No.: US 2010/0175049 A1
(43) Pub. Date: Jul. 8, 2010

(54) SCOPE: A STRUCTURED COMPUTATIONS OPTIMIZED FOR PARALLEL EXECUTION SCRIPT LANGUAGE

(75) Inventors: WILLIAM D. RAMSEY, REDMOND, WA (US); RONNIE IRA CHAIKEN, WOODENVILLE, WA (US); DARREN A. SHAKIB, NORTHBEND, WA (US); ROBERT JOHN JENKINS, JR., REDMOND, WA (US); SIMON J. WEAVER, SEATTLE, WA (US); JINGREN ZHOU, BELLEVUE, WA (US); DANIEL DEDU-CONSTANTIN, REDMOND, WA (US); ACHINT SRIVASTAVA, CAMBRIDGE, MA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/349,830

(22) Filed: Jan. 7, 2009

(51) Int. Cl. G06F 9/44; G06F 9/45; G06F 7/00

(52) U.S. Cl. 717/115; 717/139; 717/149; 717/151

(57) ABSTRACT

Embodiments of the present invention relate to systems, methods and computer storage media for providing Structured Computations Optimized for Parallel Execution (SCOPE) that facilitate analysis of a large-scale dataset utilizing row data of those data sets. SCOPE includes, among other features, an extract command for extracting data bytes from a data stream and structuring the data bytes as data rows having strictly defined columns. SCOPE also includes a process command and a reduce command that identify data rows as inputs. The reduce command also identifies a reduce key that facilitates the reduction based on the reduce key. SCOPE additionally includes a combine command that identifies two data row sets that are to be combined based on an identified joint condition. Additionally, SCOPE includes a select command that leverages SQL and C# languages to create an expressive script that is capable of analyzing large-scale data sets in a parallel computing environment.

### BACKGROUND

Massive data sets are stored and analyzed by companies to retrieve valuable information. For example, Internet search logs, Internet content collected by crawlers, and click streams collected from Internet services result in large-scale data sets that need to be analyzed in order to retrieve their wealth of information. The information that can be obtained from such large data sets includes the ability to detect changes in Internet user patterns, fraudulent activity, and to support service quality and novel Internet features.

As a result of the size of these data sets, traditional parallel database solutions can be prohibitively expensive. In an attempt to reduce the costs associated with such analysis, large-scale distributed storage and processing systems that are comprised of large clusters of commodity servers have been created. Because of the scale and parallelism of such distributed computing systems, it is challenging to design a programming model that efficiently and effectively utilizes the resources while achieving parallelism.

### SUMMARY

Embodiments of the present invention relate to systems, methods and computer storage media for providing Structured Computations Optimized for Parallel Execution (SCOPE) that facilitate analysis of a large-scale dataset. SCOPE includes, among other features, an extract command for extracting data bytes from a data stream and structuring the data bytes as date rows having strictly defined columns. The date rows support a range of data types and are not limited to a few select data types in which SCOPE is capable of handling. SCOPE also includes a process command that specifies data rows as an input. SCOPE also includes a reduce command that identifies data rows as an input as well as a reduce key that facilitates the reduction based on the reduce key. SCOPE additionally includes a combine command that identifies two data row sets that are to be combined based on an identified joint condition. Additionally, SCOPE includes a select command that leverages SQL and C# languages to create an expressive script that is capable of analyzing large-scale data sets in a parallel computing environment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts an exemplary computing device suitable for implementing embodiments of the present invention;

FIG. 2 depicts an exemplary environment suitable for implementing embodiments of the present invention;

FIG. 3 depicts an exemplary distributed software layer block diagram that is implemented in accordance with an embodiment of the present invention;

FIG. 4 depicts a block diagram of an exemplary data flow translating from a data stream, to data rows, back to a data stream, in accordance with an embodiment of the present invention;

FIG. 5 depicts a block diagram of a data flow through a process command, in accordance with an embodiment of the present invention;

FIG. 6 depicts a block diagram of a data flow through a reduce command, in accordance with an embodiment of the present invention;

FIG. 7 depicts a block diagram of a data flow through a combine command, in accordance with an embodiment of the present invention;

FIG. 8 depicts an exemplary extract scripting command, in accordance with an embodiment of the present invention;

FIG. 9 depicts an exemplary process scripting command, in accordance with an embodiment of the present invention;

FIG. 10 depicts an exemplary reduce scripting command, in accordance with an embodiment of the present invention;

FIG. 11 depicts an exemplary combine scripting command, in accordance with an embodiment of the present invention;

FIG. 12 depicts an exemplary select scripting command, in accordance with an embodiment of the present invention;

FIG. 13 depicts an exemplary output scripting command, in accordance with an embodiment of the present invention; and

FIG. 14 depicts a flow diagram of an exemplary method for providing structured computations optimized for parallel execution that facilitate analysis of a large-scale dataset, in accordance with embodiments of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Embodiments of the present invention relate to systems, methods and computer storage media for providing Structured Computations Optimized for Parallel Execution (SCOPE) that facilitate analysis of a large-scale dataset. SCOPE includes, among other features, an extract command for extracting data bytes from a data stream and structuring the data bytes as date rows having strictly defined columns. The date rows support a range of data types and are not limited to a few select data types in which SCOPE is capable of handling. SCOPE also includes a process command that specifies data rows as an input. SCOPE also includes a reduce command that identifies data rows as an input as well as a reduce key that facilitates the reduction based on the reduce key. SCOPE additionally includes a combine command that identifies two data row sets that are to be combined based on an identified joint condition. Additionally, SCOPE includes a select command that leverages SQL and C# languages to create an expressive script that is capable of analyzing large-scale data sets in a parallel computing environment.

Accordingly, in one aspect, the present invention provides computer-readable media comprising computer-executable instructions for providing Structured Computations Optimized for Parallel Execution (SCOPE) that facilitate analysis of a large-scale dataset. The step includes interpreting an extract scripting command, the extract scripting command specifying an extract data source from which an extractor, identified in the extract scripting command, extracts one or more extract data rows, to generate computer-executable instructions for applying the extractor to the data source to generate the one or more extract data rows. The steps also include interpreting a process scripting command, the process scripting command specifying one or more process input data rows from which a processor, identified in the process scripting command, generates one or more process output data rows, to generate computer-executable instructions for applying the processor to the one or more process input data rows to generate the one or more process output data rows. The steps further include interpreting a reduce scripting command, the reduce scripting command specifying one or more reduce input data rows from which a reducer, identified in the reduce scripting command, generates one or more reduce output data rows, to generate computer-executable instructions for applying the reducer to the one or more reduce input data rows to generate the one or more process output data rows, wherein the computer-executable instructions for applying the reducer to the one or more reduce input data rows guarantees that all rows in the one or more reduce input data rows that match a reduce key identified in the reduce scripting command are processed by a single call to the reducer. Additionally, the steps includes interpreting a combine scripting command, the combine scripting command specifying a joint condition, one or more first combine input data rows and one or more second combine input data rows from which a combiner, identified in the combine scripting command, generates one or more combine output data rows, to generate computer-executable instructions for applying the combiner to the first and the second combine input data rows in view of the joint condition to generate the one or more combine output data rows.

In another aspect, the present invention provides a method for providing Structured Computations Optimized for Parallel Execution (SCOPE) that facilitate analysis of a large-scale dataset. The method includes receiving, at a SCOPE computing cluster, a SCOPE script that includes one or more scripting commands that identify one or more input data rows, wherein the SCOPE script includes at least one extract scripting command for extracting the one or more input data rows from at least a portion of the large-scale dataset, further wherein the at least a portion of the large-scale dataset is identified in the SCOPE script. The method also includes compiling the SCOPE script at the SCOPE computing cluster to generate an execution plan. The method further includes storing the execution plan on a computer-readable storage medium. The method also includes generating a computational graph describing the execution at the SCOPE computing cluster. The method additionally includes storing the computational graph on a computer-readable storage medium. The method also includes executing the execution plan at the SCOPE computing cluster to provide a SCOPE plan that facilitate analysis of a large-scale dataset, wherein the execution of the execution plan includes extracting the one or more input rows data from a plurality of file extents distributed across a plurality of computing devices associated with the SCOPE computing cluster, wherein the plurality of file extents are associated with one or more data streams.

A third aspect of the present invention provides computer-readable media comprising computer-executable instructions for interpreting a Structured Computations Optimized for Parallel Execution (SCOPE) script that facilitate analysis of a large-scale dataset. The steps include interpreting the SCOPE script with reference to a library of computer-executable commands for generating a program that can be executed across a plurality of processors. The library includes an extract command for extracting one or more data rows from a data source. The library also includes a process command for taking one or more process input data rows and producing a plurality of process output data rows. The library additionally includes a reduce command for taking one or more reduce input data rows and producing a plurality of process output data rows, wherein all of the one or more reduce input data rows associated with a reduce key identified in the SCOPE script are processed in a single call. The library also includes a combine command for combining two sets of row data that share a set of combine keys identified in the SCOPE script. Additionally, the library includes a select command for manipulating row data of one or more identified data sources as row data, wherein the one or more identified data sources include data streams, row data, files, and databases, further wherein the manipulation of the row data includes at least one from the following, transforming the row data, adding a column to the row data, removing a column to the row data, filtering the row data, grouping the row data, aggregating the row data, and joining the row data. The structure of the computer executable commands in the library are compatible with SQL and C# syntax. The steps also include calling a compiler to compile the SCOPE script, wherein an execution plan results from compiling the SCOPE script. The steps additionally include storing the execution plan on one or more computer-readable media.

Having briefly described an overview of embodiments of the present invention, an exemplary operating environment suitable for implementing embodiments hereof is described below.

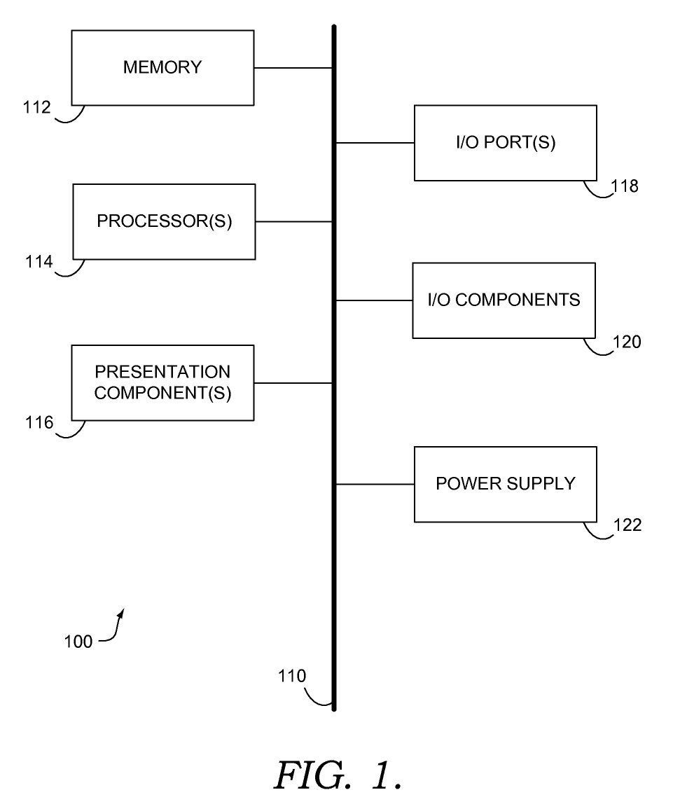

Referring to the drawings in general, and initially to FIG. 1 in particular, an exemplary operating environment suitable for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks or implements particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, and the like. I/O ports 118 allow computing device 100 to be logically coupled to other devices including I/O modules 120, some of which may be built in. Illustrative modules include a microphone, joystick, game pad, satellite dish, scanner, printer, wireless device, and the like.

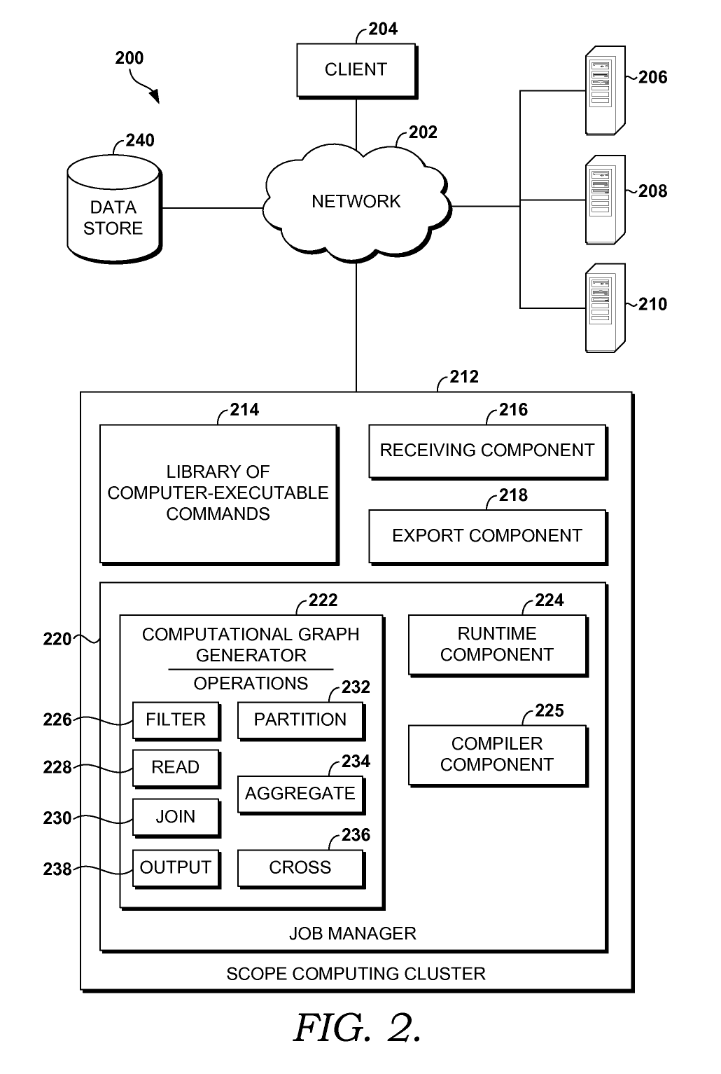

With reference to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, components, grouping of devices, components, and computing devices) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may include a client 204, a server 206, 208, and 210, a SCOPE computing cluster 212, and a data store 240. Each of the components shown in FIG. 2 may be any type of computing device, such as computing device 100 described with reference to FIG. 1, for example. The components may communicate with each other via a network 202, which may include, without limitation, one or more local area networks (LANs) and/or wide area networks (WANs). Such networking environments are commonplace in offices, enterprise-wide computer networks, intranets, and the Internet. It should be understood that any number of clients, servers, SCOPE computing clusters, and data stores may be employed within the system 200 within the scope of the present invention. Additionally other component not shown may also be included within the system 200.

The system 200 is suited to implement SCOPE scripts created by users of the client 204. For example, a user, such as a developer, system administrator, or programmer that is responsible for preparing a script that is able to perform large-scale data analysis, utilizes the client 204 to create a SCOPE script that is to be compiled and executed by the SCOPE computing cluster (e.g., SCOPE computing cluster 212) to analyze data stored in one or more data stores (e.g., the data store 240) by servers (e.g., servers 206, 208, and 210). In an exemplary embodiment, the client 204 is a computing device such as the computing device 100 discussed with respect to FIG. 1. In an additional embodiment, the client 204 includes a local compiler (not shown). The local compiler, in an embodiment, allows the user of the client 204 to validate SCOPE script at the client 204. In an alternative embodiment, the local compiler is utilized to generate an execution plan based, in part, on a SCOPE script. Therefore, the client 204 may provide a vehicle for communicating, drafting, compiling, validating, and displaying elements of a SCOPE script. In yet additional embodiment, the client 204 facilitates the communication of information between the user of the client 204 and one or more elements of the system 200 (e.g., servers 206-210, SCOPE computing cluster 212, and the data store 240).

The servers 206-210 are computing devices utilized in implementing embodiments of the present invention. In an exemplary embodiment, the servers 206-210 each include one or more processors that are utilized in a configuration conducive for parallel computing. Expanding on this embodiment, the servers 206-210 are arranged in clusters as part of a distributed computing environment. Additionally, as will be discussed later, the servers 206-210 are incorporated in the SCOPE computing cluster 212 in an exemplary embodiment. Therefore, in the previous exemplary embodiment, reference to the SCOPE computing cluster 212 includes a reference to the servers 206-210. It is understood that servers 206-210 are merely representative, and not limiting as to the scope of the present application. For example, while servers 206-210 represent three distinct servers, in reality hundreds or thousands of individual servers, racks, clusters, and pools may be implemented to effectively perform embodiments of the present invention.

In an additional exemplary embodiment, the servers 206-210 are a commodity type server that is typically less expensive relative to specialized or custom computing devices. Additionally, servers 206-210 typically include one or more disk stores (e.g., computer-readable media) that are directly attached to each of the servers 206-210. Further, the disk stores of a distributed computing environment are distributed among a plurality of the servers associated with the distributed computing environment. For example, a large-scale data set that is identified in a SCOPE script may be distributed among the servers 206-210, such that the SCOPE script, when executed, utilizes the servers 206-210 in parallel to analyze the data stored among the servers 206-210.

The SCOPE computing cluster 212 is a computing cluster for implementing aspects of a SCOPE script. In an exemplary embodiment, the SCOPE computing cluster 212 includes a library of computer-executable commands 214, a receiving component 216, an exporting component 218, and a job manager 220. The job manager 220 includes a computational graph generator 222, a runtime component 224, and a compiler component 225. The computational graph generator 222 includes a plurality of operations that may be utilized when generating a computational graph. The operations include, but are not limited to, a filter 226 operation, a read 228 operation, a join 230 operation, a partition 232 operation, an aggregate 234 operation, a cross 236 operation, and an output 238 operation.

The receiving component 216 functions to receive a SCOPE script. For example, the receiving component 216, in an exemplary embodiment receives a SCOPE script, by way of the network 202, from the client 204. The export component 218 functions to communicate information from the SCOPE computing cluster 212, the job manager 220, or other components related to the processing of a SCOPE script. For example, the export component 218 may communicate, to the client 204, information resulting from the compilation of a SCOPE script. Additionally, the export component 218 may communicate results, data, or other outputs that result from a SCOPE script. In an additional exemplary embodiment, the receiving component 216 and the export component 218 function as means for transmitting, broadcasting, and/or communicating data, information, and/or indications to and from the SCOPE computing cluster 212.

The library of computer-executable commands 214 (library 214) includes one or more computer-executable commands that are utilized when interpreting a SCOPE script. In an exemplary embodiment, the commands of the library 214 are utilized, in part, to generate a program that can be executed across a plurality of processors. For example, in a distributed computing environment that is functioning in a parallel configuration.

The commands included within the library 214 include, but are not limited to, an extract command, a process command, a reduce command, a combine command, an output command, and a select command. The commands will be discussed in greater detail at a later point. Additionally, the library 214 in an exemplary embodiment includes commands that facilitate the interpretation of custom commands included in a SCOPE script. In yet an additional exemplary embodiment, the library 214 includes commands that facilitate importing outputs from one or more scripts. For example, an import script extends view functionality across scripts, which allows for the output of a script to be utilized by additional scripts that include an import command.

The compile component 225 compiles a SCOPE script. In an exemplary embodiment, the compiler component 225 parses a SCOPE script, checks the syntax of the script, and resolves names within the script. Additionally, the compiler component 225, in an embodiment, tracks column definitions, and renaming of columns and data of row data sets. Further, for commands included in a SCOPE script that is compiled by the compiler component 225, the compiler component 225 checks that the columns are properly defined by the identified inputs. In an example, the compiler results in an internal parse tree, which can be translated directly into a physical execution plan. In this example, the physical execution plan results from utilizing default plans for each command in the SCOPE script.

In an exemplary embodiment, a physical execution plan is a specification of a distributed computing environment job. For example, such a plan may be utilized by COSMOS, a product of the Microsoft Corporation of Redmond Wash. The physical execution plan may be represented by a computational graph. In an exemplary embodiment, the computational graph is a Directed Acyclic Graph (DAG). A DAG can describe a data flow with each vertex representing a program and each edge representing a data channel. In this example, a vertex program is a serial program composed from SCOPE runtime physical operators. These runtime physical operators may in-turn call user-defined functions. In an exemplary embodiment, the operators within a vertex program are executed in a pipelined fashion, similar to a query execution in a traditional database system.

The job manager 220, in an exemplary embodiment, constructs a specified graph and schedules the execution of a SCOPE script. In this example, a vertex becomes runnable when the identified inputs are available. The execution environment monitors the state of the vertices and channels. The execution environment in this example also schedules runnable vertices for execution, determines where to run a vertex, establishes the resources required to run a vertex, and initiates the vertex program.

Continuing with this example, the translation into an execution plan from a SCOPE script is performed by traversing the parse tree from the bottom up. For each operator, SCOPE has a default implementation rule. For example, implementation of a simple filtering operation is a vertex program using a built-in physical operation of SCOPE, the filter operation. The filter operation is followed with a function that implements the filtering predicate.

In an exemplary translation, the compiler component 225 combines adjacent vertices with physical operators that can be easily pipelined into super vertices. There are four relationships between any two adjacent vertices, 1:1, 1:n, n:1, and n:m. One of the heuristics that SCOPE utilizes, in an embodiment, is to combine two vertices with 1:1 relationship. For example, if a “filter” is followed by a “sort,” SCOPE is able to combine the two operators into a single super vertex, which executes as a “filter”+“sort” in a pipelined fashion. Additionally, a vertex with a n:1 relationship can be pipelined into a 1:1 relationship or a 1:n relationship. Similarly, a 1:1 vertex may be pipelined into a 1:1 relationship or a 1:n relationship.

Returning to FIG. 2, the computational graph generator 222 generates a computational graph. For example, a DAG, as previously discussed, is an exemplary computational graph that may be generated by the computational graph generator 222. In order to generate the computational graph, one or more lower level operations may be utilized. For example, the filter 226 operation, the read 228 operation, the join 230 operation, the partition 232 operation, the aggregation 234 operation, the cross 236 operation, and the output 238 operation are lower level operations that may be utilized in a computational graph. In an exemplary embodiment, the read 228 operation allows a read from a raw data stream using an extractor. Continuing with the exemplary embodiment, the filter 226 operation allows for a read from a previous node of the graph, such as a DAG node. The partition 232 operation facilitates the partitioning of data into multiple outputs. The aggregation 234 operation combines two or more nodes into a single node, for example two DAG nodes into a single DAG node. The join 230 operation joins pairs of nodes from a computational graph. The cross 236 operation takes combinations of nodes from at least two steps and combines the nodes. Finally, with this exemplary embodiment, the output 238 operation facilitates the outputting of data back to the system. In a DAG graph, the results from one computation feeds into another computation until the computations of the DAG are completed.

In an exemplary embodiment, the computational graph generator 222 generates a computational graph that can also be displayed by a display device. For example, a computational graph that results from a SCOPE script is then communicated to the client 204 where a visual representation of the computational graph is then displayed on a display device of the client 204. In yet an additional exemplary embodiment, the computational graph is stored on a computer-readable medium, such as the data store 240.

The runtime component 224 is a runtime system that provides services for a running program but is not part of the operating system. In an exemplary embodiment, the computational graph generated by the computational graph generator 222 is provided to the runtime component 224. In an exemplary embodiment, but not limiting embodiment, the runtime component 224 utilizes a Dryad system available from the Microsoft Corporation of Redmond Wash.

Dryad is a general-purpose runtime for execution of parallel data applications. Typically, an application written for Dryad is modeled as a DAG, but as previously discussed, the program may be modeled as a generic computational graph. The DAG, in this example, defines the dataflow of the application, and the vertices of the graph define the operations that are to be performed on the data. Computational vertices are written using sequential constructs, devoid any concurrency or mutual exclusion semantics. The Dryad runtime, in this embodiment, parallelizes the dataflow graph by distributing the computational vertices across various execution engines, which can be multiple processor cores on the same computer or different physical computers connected by a network, as in a cluster. Scheduling of the computational vertices, in an exemplary embodiment, on the available hardware is handled by the Dryad runtime, without any explicit intervention by a developer of the application or an administrator of the network. The flow of data between one computational vertex to another is implemented by using communication “channels” between the vertices, which in physical implementation is realized by TCP/IP streams, shared memory, or temporary files in an exemplary embodiment.

In additional embodiments, the runtime component 224 is utilized to interpret intermediate code compiled from a development environment, such as a SCOPE script. In this example, the SCOPE script requires the runtime component 224 in order to be executed. It is understood that the requirement of a runtime component in the previous embodiment is merely exemplary and not limiting as to the scope of the present application. Intermediate code is typically code that is a result of compilation, but not executable at the machine level. Therefore, the runtime component acts as a service process that provides the framework for execution of the intermediate code and then provides the structure for it to run on an operating system.

As previously mentioned, the SCOPE computing cluster 212, in exemplary embodiments, includes a plurality of servers, such as servers 206-210, to facilitate the execution of a SCOPE script. For example, the SCOPE computing cluster 220, in an exemplary embodiment, receives a SCOPE script from the client 204 at the receiving component 216. The SCOPE script is then compiled by the compile component 225, which utilizes commands found in the library of computer-executable commands 214 to develop, in part, an execution plan. Additionally, a computational graph is generated by the computational graph generator 222, which is then provided as an input to the runtime component 224 to execute the execution plan. Continuing with this exemplary embodiment, the execution plan is executed in parallel among a plurality of servers of the SCOPE computing cluster 212, including servers 206-210. Further, the data stream that is analyzed as a result of the execution plan is pulled from a plurality of servers, such as servers 206-210, and a data store, such as the data store 240. It is understood that the data streams, databases, and data files that include the data that is to be analyzed by the SCOPE script may be stored in a distributed environment with multiple extents spread across the plurality of servers and data stores. Additionally, the extents may be stored in a redundant and reliable manner that are maintained by a distributed computing system, such as Cosmos previously discussed.

The various scripting commands to be discussed later are interpreted by one or more computing devices, such as the SCOPE computing cluster 212, the client 204, and the servers 206-210. In an exemplary embodiment, the interpretation of scripting commands located in a SCOPE script is done by the compile component 225. In yet another exemplary embodiment the interpretation of the scripting command in a SCOPE script is done by the runtime component 224 as a result of interpreting intermediate code. Therefore, the interpretation of a scripting command, which facilitates manipulating data identified in the scripting command, is performed by one or more component of FIG. 2 for a given embodiment.

Accordingly, any number of components may be employed to achieve the desired functionality within the scope of embodiments of the present invention. Although the various components of FIG. 2 are shown with lines for the sake of clarity, in reality, delineating various components is not so clear, and metaphorically, the lines would more accurately be grey or fuzzy. Further, although some components of FIG. 2 are depicted as single blocks, the depictions are exemplary in nature and in number and are not to be construed as limiting.

SCOPE, in an embodiment, is a declarative and extensible scripting language to be utilized for analyzing large-scale data sets. SCOPE allows for ease of use without requiring any explicit parallelism, while being amendable to efficient parallel execution on large clusters of computing devices. In several embodiments, SCOPE utilizes features compatible with the SQL language, while allowing expressions compatible with the C# language. The ability incorporate C# compatible expressions in a script for analysis of large-scale data sets allows for existing C# expression libraries and custom C# expressions to compute functions and scalar values or manipulate whole row sets.

In an exemplary embodiment, a SCOPE script consists of a sequence of commands. Traditionally, but not always, commands are data transformation operators that take one or more data rows (row set) as input, perform an operation on the data, and then output a data row set. In yet an additional exemplary embodiment, a command utilizes the output row set of a previous command as an input. However, SCOPE commands can also take named inputs and a user can name an output of a command using, among other options, an assignment. In an exemplary embodiment, the output of a command may be utilized one or more times by subsequent commands.

SCOPE is able to provide a scripting language that is conducive for executing on distributed data storage and processing systems. A typical distributed computing system includes a plurality of clusters that consist of hundreds or thousands of commodity computing devices that are connected by a high-bandwidth network. One exemplary difficulty with such a distributed computing network is designing a programming model that enables users to easily write programs that can effectively and efficiently utilize all resources in the distributed computing network while achieving maximum parallelism.

One solution that has been employed for a programming model in a distributed computing network is a Map-Reduce model. The Map-Reduce model requires the programmer to provide a map function that performs grouping and a reduce function that performs an aggregation. This model is limited. The users are forced to map their applications to the Map-Reduce model in order to achieve parallelism. For some applications, this mapping is very unnatural. Users are required to provide implementations for the map and reduce functions, even for simple operations. Additionally, in more complex applications that require multiple stages of Map-Reduce, there are multiple evaluation strategies and execution orders that may be selected by the user, which can result in suboptimal selection and lead to performance degradation by orders of magnitude. Further, a Map-Reduce model is typically limited to only handle string data types for both the key and the value. In addition, a Map-Reduce model requires data to be analyzed in a data stream, which results in an environment that is not intuitive to a user when developing the script. SCOPE overcomes these deficiencies in a variety of way as identified in this disclosure.

SCOPE is able to handle a variety of data types and is not limited to a select few data types. For example, SCOPE is functional to handle data types of string, integer, long, float, double, Boolean, DateTime, and byte[ ]. As previously discussed, SCOPE utilizes rows to pass information. A row object consists of a set of columns, which are strongly typed to a supported data type. In addition to supporting at least the previously mentioned data types, SCOPE is also functional to support nullable types of supported data types. While a few data types have been specified, SCOPE is not limited to the enumerated data types. Users of SCOPE are able to add additional data types to satisfy their requirements.

The utilization of rows to handle data is fundamentally different from relying on data streams. The utilization of rows allows for row level communication that provides a level of validation and system-level safety. For example, utilizing rows allows for validation at run time. This validation, in an embodiment, results from a user being able to view a computational graph that is generated from a SCOPE script. The user can therefore view the graph to validate the execution plan. Compile time checking, in an embodiment, is performed at the client-computing device. In an additional embodiment, the compile time validation is conducted at the SCOPE computing cluster.

An additional advantage of SCOPE's utilization of rows is from a programming perspective. Because rows have defined schemas that include columns with defined data types, it is easier to program against rows than a stream that lacks such definition. Further advantages of rows include their ability to facilitate creation of super-vertices, as previously discussed, and they allow objects to be passed through a system without requiring serialization to streams and deserialization from streams. Additional advantages of SCOPE's utilization of rows is the prevention of user error in data manipulation and data input because validation of the data, script, intermediate code, final code, and execution plan can be conducted at least at one of compile time and run time. This is possible, in part, because of the strong type associated with the columns of the data rows. A stream on the other hand can include arbitrary and dynamic schemes that are not conducive to such validation.

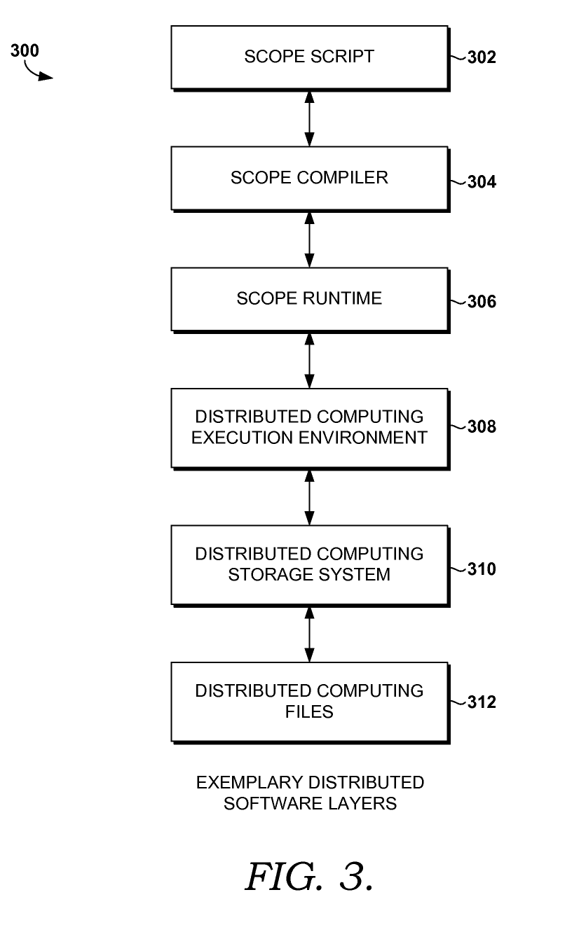

Turning to FIG. 3, an exemplary distributed software layer block diagram 300 that is implemented with embodiments of the present invention. As previously discussed, a distributed computing platform facilitates storing and analyzing massive data sets. The distributed computing platform typically satisfies several high level objectives including availability, reliability, scalability, performance, and cost.

The distributed software layer diagram 300 includes a SCOPE script 302. As previously discussed, a SCOPE script, in an exemplary embodiment, is a high-level scripting language for writing data analysis jobs. The SCOPE script 302 is compiled by the SCOPE compiler 304 to result in an efficient parallel execution plan. The execution plan, in this embodiment, is then utilized by a SCOPE runtime 306 in concert with a distributed computing execution environment 308 to provide an automatic handling fault tolerance, data partitioning resource managements, and parallelism. A computational graph is created that represents data flow of processes and edges.

A distributed computing storage system 310, in an exemplary embodiment, is an append-only file system that stores large quantities of data. In this example, the system is optimized for sequential inputs and outputs. Continuing with this example, a file is composed of a sequence of extents that are units of space allocation. Data within the extents comprise a sequence of append blocks. The block boundaries are defined by application appends that may include a collection of application defined records. Distributed computing files 312 are the data files and streams manipulated by the SCOPE script and derivatives thereof.

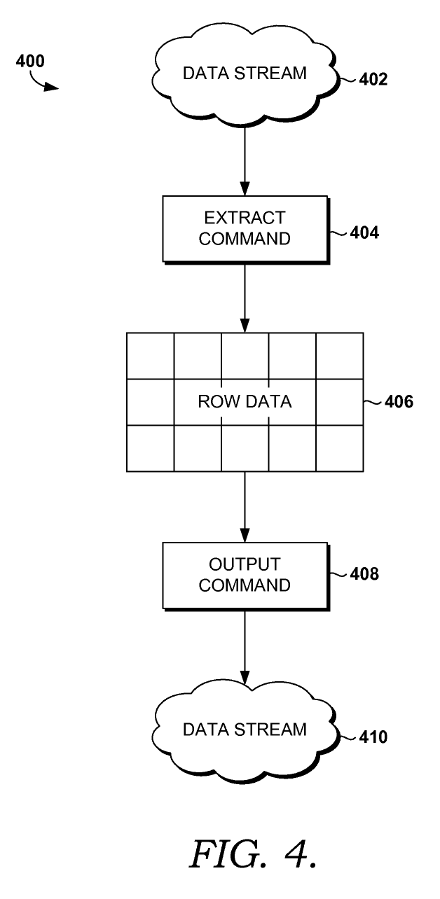

Turning to FIG. 4, a block diagram depicting an exemplary data flow 400 of a translation of data from a data stream, to data rows, back to a data stream, in accordance with embodiments of the present invention. As previously described, SCOPE manipulates data based in data rows. However, in some exemplary embodiments the data to be manipulated and analyzed is stored in a data stream. Therefore, in this example, the data of the data stream is extracted to form row data is can be manipulated by commands in SCOPE. A data stream 402 is a data stream that is to be manipulated by one or more SCOPE commands. In an exemplary embodiment, a SCOPE script will include an extract command 404.

An extract command is used to extract “rows” from a given input source. The input generally is comprised of textual or binary data. In an embodiment, it is an extractor's responsibility to decide how to translate a stream into rows. Therefore, in an exemplary embodiment, an extract command takes in an arbitrary stream and converts the stream into a sequence of row data, such as a row data 406. The data rows follow a schema identified in the extract clause. The parsing of a data stream and the construction of data rows is performed by an extractor in an exemplary embodiment. The extractor may be user written or a built-in extractor of SCOPE.

In yet another exemplary embodiment, the extractor implements at least two methods, a produces method and an extract method. The produces method is called at compile time. In this example, the produce method describes an output schema given requested columns identified in the extract command. Also in an exemplary embodiment, the output schema contains name/type pairs, where the type can be of any data type (e.g., integers, float, and double). The second method, extract method, is called at runtime. In an exemplary embodiment, the extract method utilizes the IEnumerable<Row> syntax of C# to take an input stream and yield rows. Stated differently, in this embodiment, the extract method translates a byte stream to rows.

An output command 408 is used to write data to a data stream 410, a file, or any other data sink. In an exemplary embodiment, the output command is the only way that data can exit the system. Formatting a row for output is done by calling the specified outputter. The outputter can be a SCOPE provided outputter, or in an additional embodiment, the outputter is a user-defined outputter, such as an outputter created from extending the C# class “outputter.” In an additional embodiment, if an outputter is not specified, a default outputter is utilized.

Therefore, an exemplary SCOPE script for extracting columns A-E from a data stream identified as “sample.in” utilizing an extractor identified as “MyExtractor” is represented as follows in one exemplary embodiment.

EXTRACT A,B,C,D,E

FROM “sample.in”

USING MyExtractor;

The row data that is extract from sample.in may then be further manipulated with additional commands or it may be output back to a data stream utilizing the output command. In an exemplary embodiment, the row data is written to a data stream identified as “sample.out” utilizing the following command.

OUTPUT TO “sample.out”;

As previously discussed, in an embodiment, an extractor is either a built-in extractor or a custom extractor. One example of an extractor, identified as MyExtractor, is as follows.

```
public class MyExtractor : Extractor
{
  public override Schema Produces(string[ ] requestedColumns,
  string[ ] args)
  {
    return new Schema(requestedColumns);
  }
  public override IEnumerable<Row> Extract(StreamReader reader, Row
outputRow, string[ ] args)
  {
    string line;
    while ((line = reader.ReadLine( )) != null)
    {
      string[ ] tokens = line.Split(‘,’);
      for (int i = 0; i < tokens.Length; ++i)
      {
        outputRow[i].UnsafeSet(tokens[i]);
      }
      yield return outputRow;
    }
  }
}
```

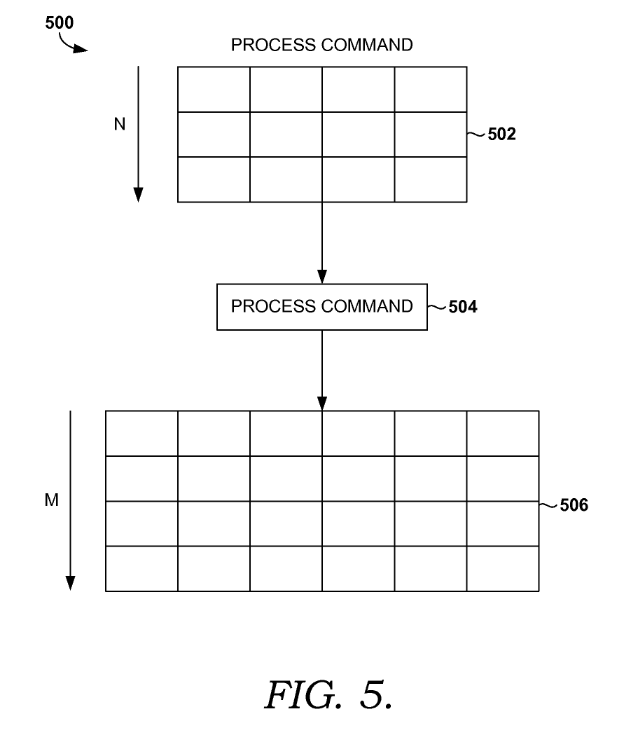

Turning now to FIG. 5, a block diagram depicting a data flow 500 through a process command 504 is provided in accordance with embodiments of the present invention. An initial row set 502 with “N” number of columns is provided as an input to the process command 504. A resulting row set 506 is the output of the process command 504, such that the resulting row set 506 has “M” number of rows.

The process command will take an arbitrary number of rows (data rows) and produce an arbitrary number of rows in return. The process command operates without regard for the order in which rows are passed to it. In an exemplary embodiment, the process command is utilized for filtering data, such as removing rows that do not meet specified criteria. The process command is also useable for adding or removing columns from input data rows. Additionally, the process command is useable for transforming data of input data rows. For example, taking variables A, B, and C and producing A, B, C, and D. Where D is some defined function of the A, B, and C variables.

The following is an exemplary portion of an exemplary SCOPE script that includes a process command.

PROCESS

PRODUCE A, B, C, D, E

USING MyProcessor;

The process command produces A, B, C, D, and E from an input of data rows utilizing a processor. The processor, similar to the previously described extractor can be built-in to SCOPE or a custom extractor. In an exemplary embodiment, the actual work of the process command is done by the processor. The processor retrieves one input row at a time, performs some computation on the row, and outputs zero to multiple rows.

In an exemplary embodiment, the process command is a flexible command that allows a user to implement processing that is difficult or impossible to express in SQL alone. The processing command is capable of returning multiple rows per input row, which in one embodiment allows for unnesting capabilities. For example, the process command can break an input search string into a series of words and return one row for each of these words.

An exemplary processor that may be called by a process command is as follows.

```
      public class MyProcessor : Processor
{
  public override Schema Produces(string[ ] columns, string[ ] args,
Schema upstream)
  {
    return new Schema(“A:int,B:double,C,D,E”);
  }
  public override IEnumerable<Row> Process(RowSet input, Row
outputRow, string[ ] args)
  {
    foreach (Row row in input.Rows)
    {
      int A = row[0].Integer + 5;
      double B = A * row[1].Double;
      string C = row[0].String + row[3].String;
      string D = C + B.ToString( );
      string E = C + row[2].String;
      if (A > 10 || C.Contains(“foo”))
      {
        outputRow[0].Set(A);
        outputRow[1].Set(B);
        outputRow[2].Set(C);
        outputRow[3].Set(D);
        outputRow[4].Set(E);
        yield return outputRow;
      }
    }
  }
}
```

Similar to the two methods discussed with respect to the extractor command, the process command also implements two methods, the produces method and the process method. The produces method and the process method function as previously described, such as the produces method is called at compile time and the process command is called at run time.

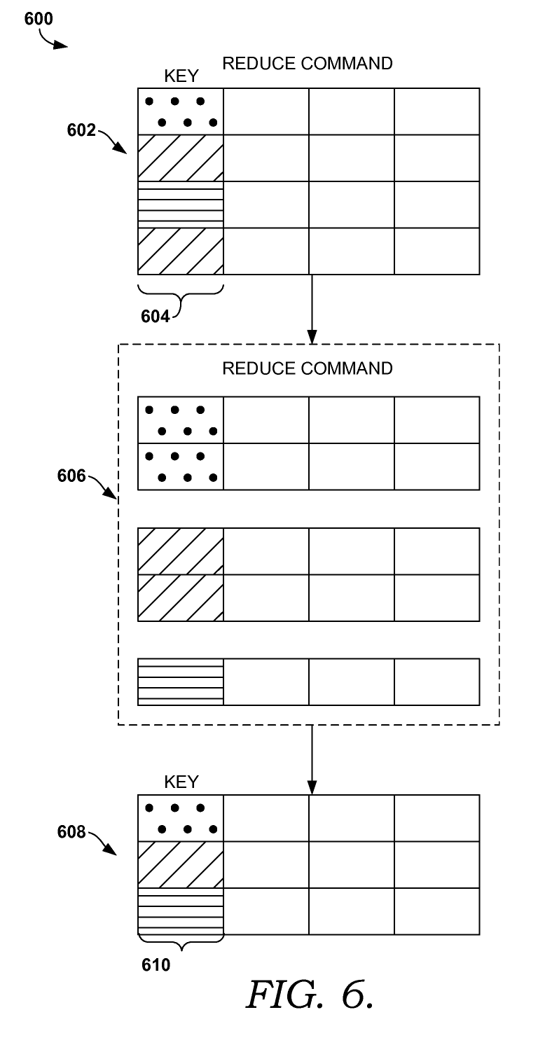

Turning to FIG. 6, a block diagram depicting an exemplary data flow 600 utilizing a reduce command 606 is provided in accordance with an exemplary embodiment of the present invention. A reduce command is similar to a process command previously discussed. However, the semantics are significantly different between the reduce command and the process command. This is in part because the process command cannot guarantee anything about the order in which rows are processed, the reduce command guarantees that all rows in the system matching a given key will be processed by a single call to a reducer. In exemplary embodiments, the implementation of the reducer is similar to that of the processor.

For example, a row set 602 (set of data rows) is input to the reduce command 606. The row set 602 includes a number of rows and a number of columns. One of the columns of the row set 602 includes a key value for each of the rows that comprise the row set 602. The column with the keys, key column 604, indicates at least three unique keys in this example. The input is grouped based on the keys and fed into the reduce command one grouping at a time. The reduce command 606 generates an output data set 608. The output data set 608 is reduced based on the keys 610.

In an exemplary embodiment the reduce command takes as input a row set that has been grouped on a grouping column that is specified in an “ON” call of the reduce command. The reduce command continues by processing each group and outputs zero to multiple rows per group. The reduce function is called once per group. In some embodiments, the reducer of a reduce command may require the row within each group to be sorted on specific columns. This can be achieved with a presort clause. This prevents from having to sort the input within a reducer.

The following is an exemplary reduce command that may be included in a SCOPE script.

REDUCE

ON key

PRODUCE key, A, B, C, D

USING MyReducer;

In an exemplary embodiment, the reduce command utilizes a reducer to reduce the input data rows to the output data rows. A reducer, similar to the previously discussed extractor, includes built-in reducers and user generated reducers. The following is an exemplary reducer that may be called by a reduce command.

```
      public class MyReducer : Reducer
{
  public override Schema Produces(string[ ] columns, string[ ] args,
Schema upstream)
  {
    return new Schema(“A:int,B:double,C,D,E”);
  }
  public override IEnumerable<Row> Reduce(RowSet input, Row
outputRow, string[ ] args)
  {
    int count = 0;
    foreach (Row row in input.Rows)
    {
      if (++count == 1)
      {
        row.Copy(outputRow);
      }
    }
    outputRow[4].Set(count);
    yield return outputRow;
  }
}
```

Similar to the two methods discussed with respect to the extractor command, the process command also implements two methods, the produces method and the process method. The produces method and the extract method function as previously described, such as the produces method is called at compile time and the process command is called at run time.

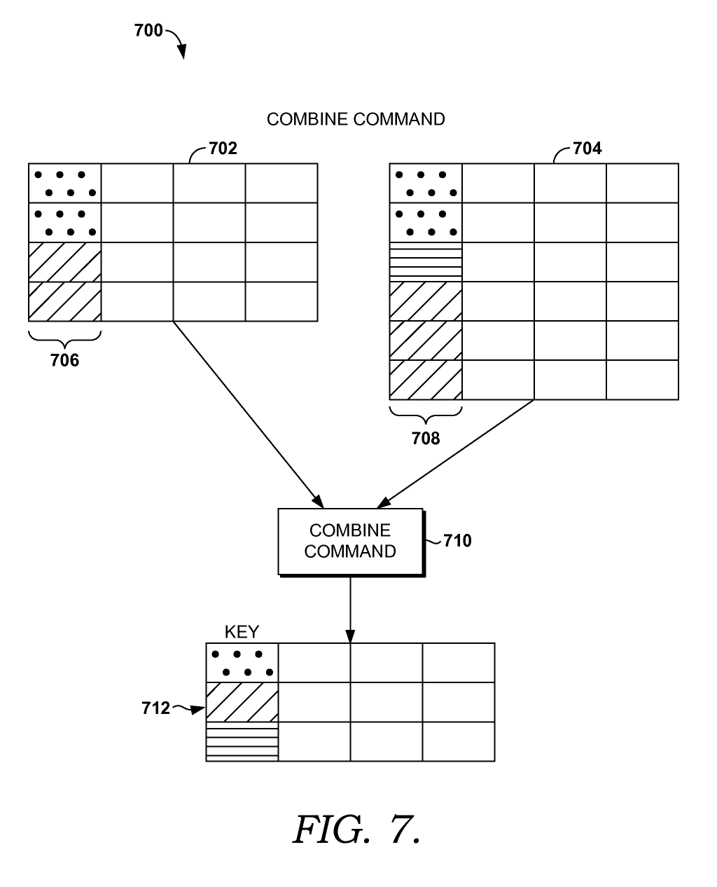

Turning to FIG. 7, a block diagram depicting an exemplary data flow 700 utilizing a combine command 710. The combine command 710 is utilized to combine two sets of rows sharing a set of keys. This is similar to the reduce command, except two row sets are operated on at a single time. In an exemplary embodiment, the combine command is used to join data. Additionally, the combine command, in an exemplary embodiment, allows for the combining of two sets of rows to produce a new set of rows. The combine command can guarantee that all rows having a shared key from the two row sets will be processed in one call to the combiner.

For example, a first data input row set 702 having keys 706 and a second input row set 704 having keys 708 are the input to the combine command 710. The combine command 710 then combines the first input row set 702 and the second input row set 704 based on the keys 706 and 708. The output of the combine command 710 is a row set 712. The row set 712 is combined based on the keys of the input row sets. Additionally, the key may be referenced as a joint condition. For example, a joint condition for combination includes table1.A==table2.A. The join condition, in this example, combines when the value (key) of a column A in a first table is equivalent to the value (key) of a column A in a second table. In an additional embodiment of the present invention, the joint condition is not a typical equality condition, but rather an expression. Therefore, SCOPE is not limited to utilizing only equality conditions, but instead may rely on one or more expressions. In this embodiment, the semantics and runtime behavior will differ when an expression is utilized in place of an equality condition.

In an exemplary embodiment, the two input data sets must be grouped in the same manner for the combiner to receive the groups as an input. The combiner, in this example, then processes the rows within each matching group to produce output rows. This particular example allows for partitioning and distributed processing of the inputs.

The following is an exemplary combine command that may be included in a SCOPE script.

table1=EXTRACT A,B,C,D

FROM “vol1/users/brams/sample.in”

USING DefaultTextExtractor;

table2=EXTRACT A,B,C,D

FROM “vol1/users/brams/sample.in”

USING DefaultTextExtractor;

COMBINE table1 WITH table2

ON table1.A==table2.A

USING MyCombiner;

In an exemplary embodiment, the combine command utilizes a combiner to combine the input data sets based on a joint condition. The combiner, similar to the extractor, can be either a SCOPE provided combiner or a user created combiner. The following is an exemplary combiner.

```
public class MyCombiner : Combiner
{
    public override Schema Produces( string[ ] columns, string[ ] args,
Schema left,
                  string leftAlias, Schema right, string rightAlias)
    {
        return new Schema(columns);
    }
    RowList list = new RowList( );
    public override IEnumerable<Row> Combine(RowSet left,
RowSet right, Row output, string[ ] args)
    {
      foreach(Row leftRow in left.Rows) { list.Add(leftRow); }
      foreach(Row rightRow in right.Rows)
      {
      outputRow[1].Set(rightRow[0].String);
      foreach(Row leftRow in list.Rows)
    {
        output[0].Set(leftRow [0].String);
        yield return output;
      }
      }
    }
}
```

Additional commands that are functional in a SCOPE script include a select command, a join command, and an import command. The select command is a command that is patterned after an SQL select statement, thus allowing SCOPE to leverage the SQL language. A select command is capable of performing a variety of services, such as transforms, add columns, remove columns, filter data, group data, and join data. The select command can join multiple inputs utilizing inner and outer joins. Multiple aggregation functions are supported with a SCOPE select command. Examples include COUNT, COUNTIF, MIN, MAX, SUM, AVG, STDEV, VAR, FIRST, and LAST. It is understood that while multiple aggregation functions have been listed, additional functions are within the scope of the present invention. The select command provides expression to the SCOPE language through the leveraging of SQL, C#, and/or .NET expressions. Exemplary select commands include, but are not limited to the following select commands in accordance with embodiments of the present invention. A transform select command may be provided in SCOPE as:

SELECT A.Substring(0,3) AS ShortA,

B+C AS Z.

An exemplary select command for grouping may be represented in SCOPE as the following:

SELECT Query, COUNT( ) AS Count WHERE Query.StartsWith(“a”)

HAVING Count>50.

An exemplary select command for joining may be represented in SCOPE as the following:

SELECT a.A, b.B

FROM a,b

WHERE a.A==b.A.

It is understood by those with ordinary skill in the art that the previously discussed select command examples are merely representative and not limiting as to the scope of the present invention. For example, the select command is functional to provide more complex operations that allow SCOPE to be a dynamic, flexible, and powerful scripting language.

Additionally, in an embodiment, the select command is able to leverage all functions and operators of C# to make those functions and operators available in SCOPE. Users of SCOPE are also able to write their own functions. In an embodiment, the definition of a user-defined function is included within the SCOPE script. The following example illustrates the use of C# string functions and shows how to write a user-defined function. In the following example, columns A, B, and C are all of type string and, consequently, any of the C# string functions may be utilized in this embodiment. The user-defined function in the following example, “StringOccurs”, counts the number of occurrences of a given pattern string in an input string. The example is as follows:

```
R1 = SELECT A+C AS ac, B.TRIM( ) AS B1
    FROM R
    WHERE StringOccurs (C, “xyz”) > 2
#CS
public static
int StringOccurs(string str, string ptrn)
{
    int cnt=0; int pos=−1;
    while (pos+1 , str.Length) {
        pos = str.IndexOf(ptrn, pos+1) ;
        if (pos < 0) break;
    }
    return cnt;
}
#ENDCS
```

Where in the above example, the expression A+C denotes string contenation because both operands are strings. The C# function “Trim” strips white space from the beginning and the end of the string. The user-defined function StringOccurs is included in the SCOPE script in a section delimitated by #CS and #ENDCS. It is understood that the previously example of a user-defined function within a SCOPE script is merely for explanatory purposes and is not intended to be limiting as to the scope of the present invention.

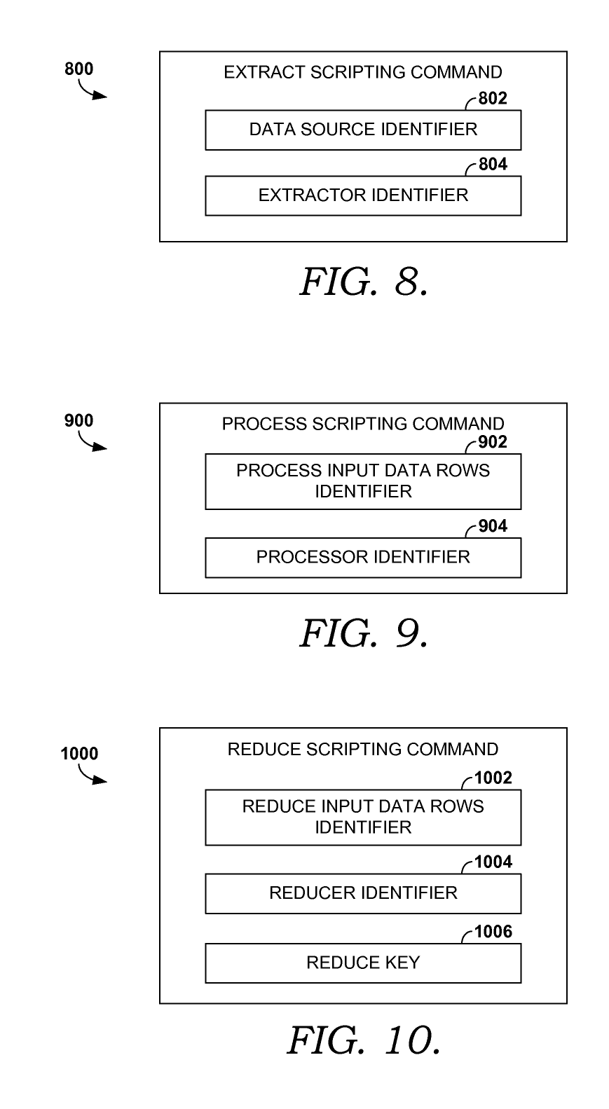

Turning to FIG. 8, a block diagram depicting an exemplary extract scripting command 800. The extract scripting command 800 includes a data source identifier 802 and an extractor identifier 804. A data source identifier, such as the data source identifier 802, is an identifier of a data source, such as an input data stream. In an exemplary embodiment, the data source identifier identifies a particular data stream from which data is to be extracted for producing one or more data rows. The extractor identifier 804 identifies an extractor to be called for performing the extraction identified in an extract command. The “MyExtractor” example previously discussed with respect to FIG. 4 is an exemplary extractor identifier 804, which facilitates the extraction of data from a data source to be represented as rows. It is understood that the extract scripting command 800, is not limited to including the data source identifier 802 and the extractor identifier 804. The extract scripting command 800 may also include additional expressions, such as a having expression, where the having expression facilitates a filtering operation that discards rows from the output that do not meet an identified condition.

Turning to FIG. 9, a block diagram depicting an exemplary process scripting command 900. The process scripting command 900 includes a process input data rows identifier 902 and a processor identifiers 904. The process input data rows identifier 902 identifies one or more data rows that are the input for the process scripting command 900. For example, an identifier includes a file name, a file location, a stream name, a stream location, a particular extent, a database, or other recognized identifiers for a particular data group. Additionally, in an exemplary embodiment, the process input data rows identifier 902 is an output of an extract command.

The processor identifier 904 is an identifier of a processor that will be called as a result of the process scripting command 900. The “MyProcessor” previously discussed with respect to FIG. 5 is one example of a processor identifier 904. It is understood that the process scripting command 900, is not limited to including the process input data rows identifier 902 and the processor identifier 904. The process scripting command 900 may also include additional expressions, such as a having expression, where the having expression facilitates a post-filtering of the output rows without the need for a separate select command.

Turning to FIG. 10, a block diagram depicting an exemplary reduce scripting command 1000. The reduce scripting command 1000 includes a reduce input data rows identifier 1002, a reduce identifier 1004, and a reduce key 1006. The reduce input data rows identifier 1002 is an identifier of one or more data rows to be input as a result of the reduce scripting command 1000. As discussed with respect to FIG. 9, in some embodiments the input for a command is the output from an extract command. Additionally, in an exemplary embodiment, the default input for a given command is the output of a subsequent command.

The reducer identifier 1004 is an identifier of a reducer to be called as a result of the reduce scripting command 1000. The “MyReducer” discussed with respect to FIG. 6 is an exemplary reducer identifier 1004. The reduce key 1006 is a key on which the input data is reduced. For example, the exemplary SCOPE reduce command in FIG. 6 includes the “key” argument following the “ON” call. The “key” argument identifies a key on which the data is reduced.

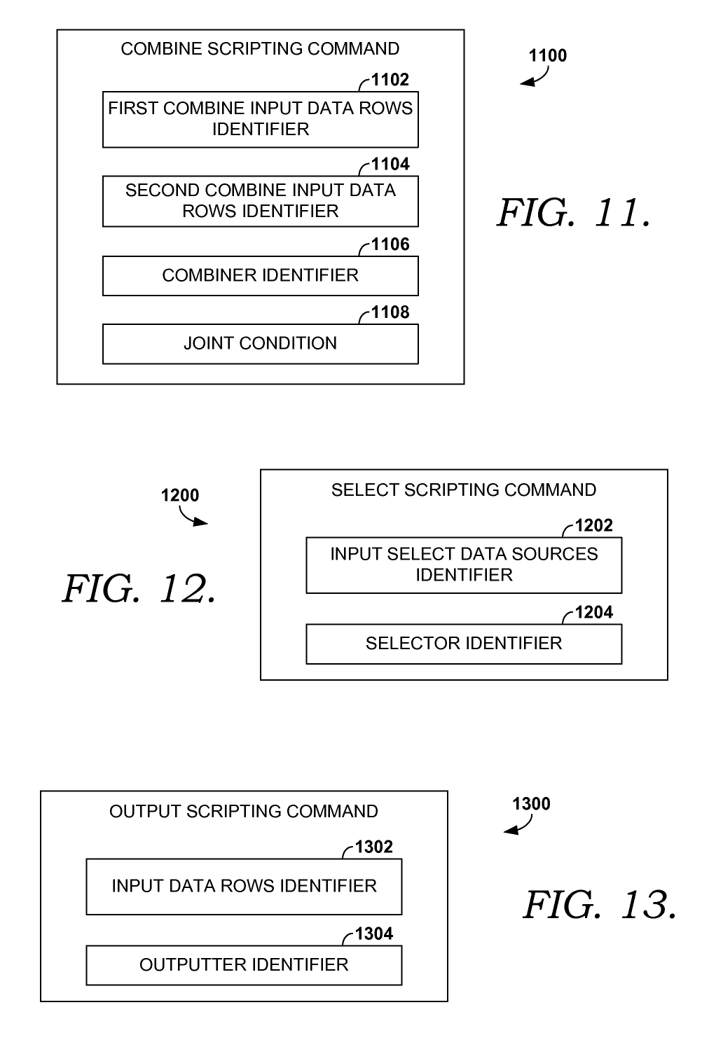

Turning to FIG. 11, a block diagram depicting an exemplary combine scripting command 1100. The combine scripting command 1100 includes a first combine input data rows identifier 1102, a second combine input data rows identifier 1104, a combiner identifier 1106, and a joint condition 1108. The first and second combine input data rows identifier 1102 and 1104 identify input data rows that are intended to be combined as indicated by the combine scripting command 1100. The combiner identifier 106 identifies a combiner to be utilized in combining the first and second combine input data rows identifiers 1102 and 1104. For example, the “MyCombiner” previously discussed with respect to FIG. 7 is one example of a combiner identifier 1106. The joint condition 1108 is a condition on which the first and second combine input data rows identifiers 1102 and 1104 are combined. For example, the “table1.A table2.A” condition described with respect to FIG. 7, is one example of a joint condition 1108.

Turning to FIG. 12, a block diagram depicting an exemplary select scripting command 1200. The select scripting command 1200 includes an input select data source identifier 1202 and a selector identifier 1204. In an exemplary embodiment, the select scripting command 1200 leverages an SQL select statement to manipulate data in one or more data sources. The ability to leverage SQL, C#, and/or .NET expressions in a SCOPE script and in particular a select command further enables SCOPE to be an expressive language. The selector identifier 1204 identifies a selector for manipulating data identified by the input select data sources identifier 1202. It is understood that in addition to the utilization of a selector, the select scripting command 1200, in an exemplary embodiment, includes one or more SQL, C#, or .NET expression for manipulating data.

Turning to FIG. 13, a block diagram depicting an exemplary output scripting command 1300. The output scripting command 1300 includes an input data rows identifier 1302 and an outputter identifier 1304. The input data rows identifier 1302 is an identifier of one or more data rows that is to be output as a file, stream, or other format. The outputter identifier 1304 is an outputter called by the output scripting command 1300 for outputting the data identified by the input data rows identifier 1302.

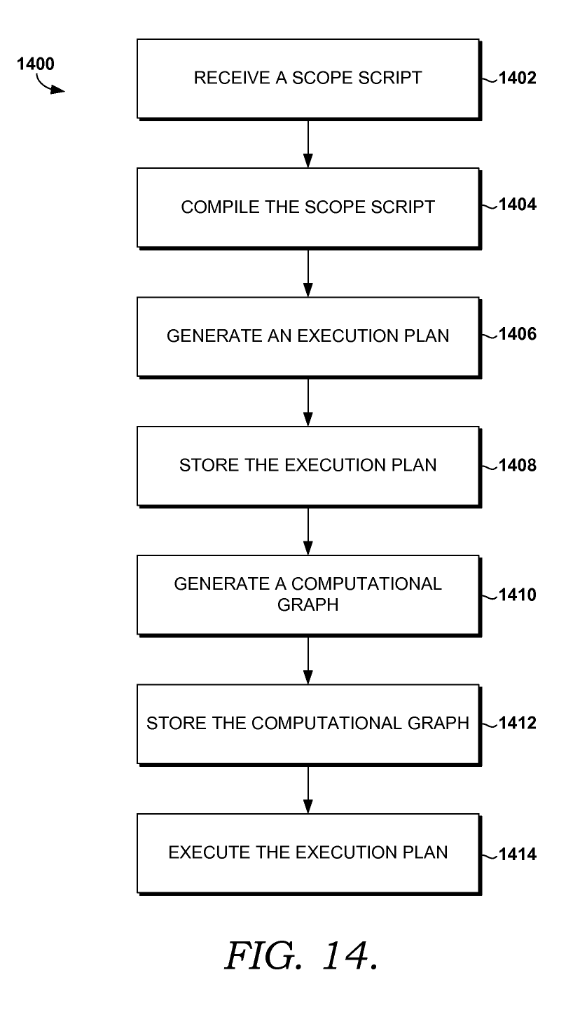

Turning to FIG. 14, a flow diagram that depicts an exemplary method 1400 for providing structured computations optimized for parallel execution that facilitate analysis of a large-scale dataset, in accordance with embodiments of the present invention. As indicated at a block 1402, a SCOPE script is received. In an exemplary embodiment, a SCOPE script is received from a client-computing device, such as the client 204 previously discussed with respect to FIG. 2. In yet an additional exemplary embodiment, a SCOPE script is received at a SCOPE computing cluster, such as by way of the receiving component 216 of the SCOPE computing cluster 212 also previously discussed with respect to FIG. 2. Generally, the SCOPE script includes one or more scripting commands, such as an extract command, a process command, a reduce command, a combine command, a select command, an output command, or any combination thereof. The scripting commands typically identify one or more input data rows.

As indicated at a block 1404, the SCOPE script is compiled. In an exemplary embodiment, the SCOPE script is compiled at a SCOPE computing cluster. However, in additional embodiments the SCOPE script is compiled at a client device. A result of compiling the SCOPE script is the generation of an execution plan, as indicated at a block 1406. The execution plan is stored in a computer-readable storage medium, as indicated at a block 1408. As shown at a block 1410, a computational graph is generated. In an exemplary embodiment the computational graph is generated by the computational graph generator 222 previously discussed with respect to FIG. 2. The computational graph, in an exemplary embodiment is a DAG graph that is also displayed to a user on a display device. The DAG graph can be analyzed for compile time checking of the SCOPE script. The resulting computation graph is stored on a computer-readable storage medium, as indicated at a block 1412. As shown at a block 1414, the execution plan is executed.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and sub combinations are of utility, may be employed without reference to other features and sub combinations, and are contemplated within the scope of the claims. Not all steps listed in the various figures need be carried out in the specific order described.

The invention claimed is:

1. One or more computer-readable media comprising computer-executable instructions for providing structured computations optimized for parallel execution that facilitate analysis of a large-scale dataset, the computer-executable instructions directed to the steps comprising:
interpreting an extract scripting command, the extract scripting command specifying an extract data source from which an extractor, identified in the extract scripting command, extracts one or more extract data rows, to generate computer-executable instructions for applying the extractor to the data source to generate the one or more extract data rows;
interpreting a process scripting command, the process scripting command specifying one or more process input data rows from which a processor, identified in the process scripting command, generates one or more process output data rows, to generate computer-executable instructions for applying the processor to the one or more process input data rows to generate the one or more process output data rows;
interpreting a reduce scripting command, the reduce scripting command specifying one or more reduce input data rows from which a reducer, identified in the reduce scripting command, generates one or more reduce output data rows, to generate computer-executable instructions for applying the reducer to the one or more reduce input data rows to generate the one or more process output data rows, wherein the computer-executable instructions for applying the reducer to the one or more reduce input data rows guarantees that all rows in the one or more reduce input data rows that match a reduce key identified in the reduce scripting command are processed by a single call to the reducer; and
interpreting a combine scripting command, the combine scripting command specifying a joint condition, one or more first combine input data rows and one or more second combine input data rows from which a combiner, identified in the combine scripting command, generates one or more combine output data rows, to generate computer-executable instructions for applying the combiner to the first and the second combine input data rows in view of the joint condition to generate the one or more combine output data rows.

2. The computer-readable media of claim 1, wherein the extract data source is one of a data stream, a data file, and database.

3. The computer-readable media of claim 1, wherein the extractor and the processor implement two methods, a produces method and an extract method.

4. The computer-readable media of claim 1, wherein at least one of the following, the one or more process input data rows, the one or more reduce input rows, the one or more reduce input data rows, the one or more first combine data rows, and the one or more second combine data rows include the one or more extract data rows.

5. The computer-readable media of claim 1, wherein the processor operates without distinction as to an order in which the one or more process input data rows are passed to the processor.

6. The computer-readable media of claim 1, wherein at least one of a where clause and a having clause is utilized by at least one of the scripting commands to filter data represented in data rows.

7. The computer-readable media of claim 1, wherein the reduce scripting command allows for all rows identified to be manipulated in a single call to be manipulated in a single call.

8. The computer-readable media of claim 1, wherein the reduce key is a value identifiable in the one or more reduce input data rows.

9. The computer-readable media of claim 1, further comprising interpreting an output scripting command, the output scripting command specifying one or more input data rows to which an outputter, identified in the extract scripting command, outputs the one or more input data rows as a data sink, to generate computer-executable instructions for applying the outputter to the one or more input data rows to generate the data sink.

10. The computer-readable media of claim 1.9, wherein the data sink is a data stream.

11. The computer-readable media of claim 1, wherein the one or more computer-readable media comprising computer-executable instructions for providing structured computations optimized for parallel execution that facilitate analysis of a large-scale dataset is capable of interpreting the extract scripting command, the process scripting command, the reduce scripting command, and the combine scripting command that includes SQL compatible instructions.

12. The computer-readable media of claim 1, wherein the one or more computer-readable media comprising computer-executable instructions for providing structured computations optimized for parallel execution that facilitate analysis of a large-scale dataset are capable of interpreting the extract scripting command, the process scripting command, the reduce scripting command, and the combine scripting command that includes C# compatible instructions.

13. The compute-readable storage media of claim 1, further comprising interpreting a select scripting command, the select scripting command specifying one or more input select data sources to which a selector, identified in the select scripting command, manipulates the one or more input select data sources based on one or more functions and commands identified in the select scripting command, to generate computer-executable instructions for applying the selector to the one or more input select data sources.

14. A method for providing Structured Computations Optimized for Parallel Execution (SCOPE) that facilitate analysis of a large-scale dataset, the method comprising:
receiving, at a SCOPE computing cluster, a SCOPE script that includes one or more scripting commands that identify one or more input data rows, wherein the SCOPE script includes at least one extract scripting command for extracting the one or more input data rows from at least a portion of the large-scale dataset, further wherein the at least a portion of the large-scale dataset is identified in the SCOPE script;
compiling the SCOPE script at the SCOPE computing cluster to generate an execution plan;
storing the execution plan on a computer-readable storage medium;
generating a computational graph describing the execution at the SCOPE computing cluster;
storing the computational graph on a computer-readable storage medium; and
executing the execution plan at the SCOPE computing cluster to provide a SCOPE plan that facilitate analysis of a large-scale dataset, wherein the execution of the execution plan includes extracting the one or more input rows data from a plurality of file extents distributed across a plurality of computing devices associated with the SCOPE computing cluster, wherein the plurality of file extents are associated with one or more data streams.

15. The method of claim 14, wherein the scripting commands include at least one from the following, a process scripting command, a reduce scripting command, a combine scripting command, and a select scripting command.

16. The method of claims 15, wherein the output of the scripting commands are one or more data rows with a defined schema.

17. The method of claim 14 further comprising determining if the SCOPE script properly compiled, when it is determined that the SCOPE script failed to properly compile, providing an indication the scope script failed to properly compile.

18. The method of claim 14, wherein the SCOPE script is structured to support all of the following data types, string, integer, long, float, double, Boolean, DateTime, byte[ ], and nullable counterparts to data types.

19. The method of claim 14, wherein the computational graph is a Directed Acyclic Graph (DAG).

20. One or more computer-readable media comprising computer-executable instructions for interpreting a Structured Computations Optimized for Parallel Execution (SCOPE) script that facilitate analysis of a large-scale dataset, the computer-executable instructions directed to the steps comprising:
interpreting the SCOPE script with reference to a library of computer-executable commands for generating a program that can be executed across a plurality of processors, the library comprising:
i) an extract command for extracting one or more data rows from a data source,
ii) a process command for taking one or more process input data rows and producing a plurality of process output data rows.
iii) a reduce command for taking one or more reduce input data rows and producing a plurality of process output data rows, wherein all of the one or more reduce input data rows associated with a reduce key identified in the SCOPE script are processed in a single call,
iv) a combine command for combining two sets of row data that share a set of combine keys identified in the SCOPE script, and
v) a select command for manipulating row data of one or more identified data sources as row data, wherein the one or more identified data sources include data streams, row data, files, and databases, further wherein the manipulation of the row data includes at least one from the following, transforming the row data, adding a column to the row data, removing a column to the row data, filtering the row data, grouping the row data, aggregating the row data, and joining the row data,
wherein the structure of the computer executable commands of the library are compatible with SQL and C# syntax;
calling a compiler to compile the SCOPE script, wherein an execution plan results from compiling the SCOPE script; and
storing the execution plan on one or more computer-readable media.
